(19) United States
(12) Patent Application Publication
(10) Pub. No.: US 2010/0265186 A1
(43) Pub. Date: Oct. 21, 2010

(54) Method and Apparatus for Performing Selection Based on a Touch Input

(75) Inventor: Elisa Katariina Ryynanen, Tokyo (JP)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/426,044

(22) Filed: Apr. 17, 2009

(51) Int. Cl. G06F 3/041

(52) U.S. Cl. 345/173

(57) ABSTRACT

An apparatus, that may comprise a processor configured to receive a touch input associated with a first contact region, determine a first linear shape associated with the first contact region, receive a change in the touch input associated with a second contact region, determine a second linear shape associated with the second contact region, and perform selection based at least in part on the first linear shape, the touch input, the change in the touch input, and the second linear shape is disclosed. A corresponding method, computer readable medium, and computer program product are also disclosed.

### RELATED APPLICATIONS

This application relates to U.S. Patent Application, entitled “METHOD AND APPARATUS FOR PERFORMING OPERATIONS BASED ON TOUCH INPUTS,” which is being filed concurrently and is hereby incorporated by reference in its entirety.

### TECHNICAL FIELD

The present application relates generally to touch input selection.

### BACKGROUND

There has been a recent surge in the use of touch displays on electronic devices. Some of these devices allow a user to select one or more visual representations of information using the touch display.

### SUMMARY

Various aspects of examples of the invention are set out in the claims. According to a first aspect of the present invention, an apparatus, that may comprise a processor configured to receive an indication of a touch input associated with a first contact region, determine a first linear shape associated with the first contact region, receive an indication of a change in the touch input associated with a second contact region, determine a second linear shape associated with the second contact region, and perform selection based at least in part on the first linear shape, the touch input, the change in the touch input, and the second linear shape is disclosed.

According to a second aspect of the present invention, a method, that may comprise receiving an indication of a touch input associated with a first contact region, determining a first linear shape associated with the first contact region, receiving an indication of a change in the touch input associated with a second contact region, determining a second linear shape associated with the second contact region, and performing selection based at least in part on the first linear shape, the touch input, the change in the touch input, and the second linear shape is disclosed.

According to a third aspect of the present invention, a computer program product comprising a computer-readable medium bearing computer program code embodied therein for use with a computer, the computer program code comprising code for receiving an indication of a touch input associated with a first contact region, code for determining a first linear shape associated with the first contact region, code for receiving an indication of a change in the touch input associated with a second contact region, code for determining a second linear shape associated with the second contact region, and code for performing selection based at least in part on the first linear shape, the touch input, the change in the touch input, and the second linear shape is disclosed.

According to a fourth aspect of the invention, a computer-readable medium encoded with instructions that, when executed by a computer, perform receiving an indication of a touch input associated with a first contact region, determining a first linear shape associated with the first contact region, receiving an indication of a change in the touch input associated with a second contact region, determining a second linear shape associated with the second contact region, and performing selection based at least in part on the first linear shape, the touch input, the change in the touch input, and the second linear shape is disclosed.

### BRIEF DESCRIPTION OF THE DRAWINGS

For a more complete understanding of example embodiments of the present invention, reference is now made to the following descriptions taken in connection with the accompanying drawings in which:

FIGS. 1A-1H are diagrams illustrating a contact associated with a touch input according to an example embodiment of the invention;

FIGS. 2A-2G are diagrams illustrating a linear shape associated with a contact region associated with a touch input according to an example embodiment of the invention;

FIG. 3A-3G are diagrams illustrating a selection region according to an example embodiment of the invention;

FIGS. 4A-4C are diagrams illustrating a selection region in relation to visual representations of information items;

FIG. 5 is a flow diagram showing a set of operations for performing selection based on touch input and shape of contact region according to an example embodiment of the invention;

FIGS. 6A-6E are diagrams illustrating input from a touch display according to an example embodiment of the invention; and

FIG. 7 is a block diagram showing an apparatus according to an example embodiment of the invention.

### DETAILED DESCRIPTION OF THE DRAWINGS

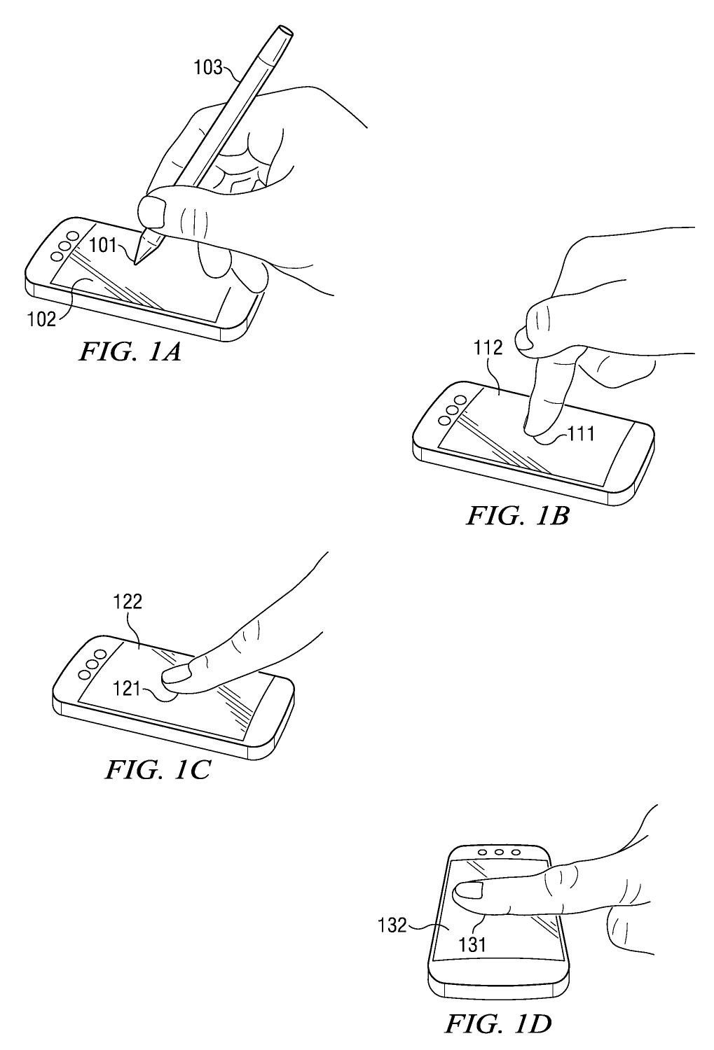

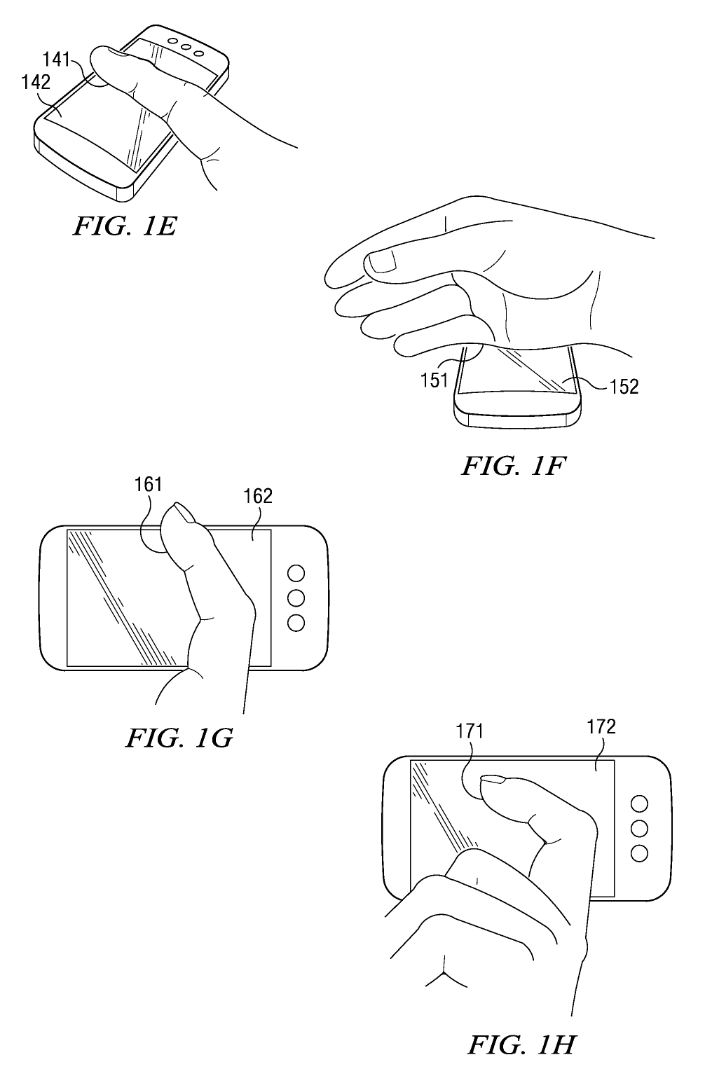

An example embodiment of the invention and its potential advantages are understood by referring to FIGS. 1A through 7 of the drawings.

In an example embodiment, a user provides touch input to an apparatus using various contacts with the touch display. In such an embodiment, the apparatus may perform different operations based upon the different contacts.

FIGS. 1A-1J are diagrams illustrating a contact associated with a touch input according to an example embodiment of the invention. The examples of FIGS. 1A-1J are merely examples of contacts and do not limit the invention. For example, a different body part, such as a wrist, elbow, foot, toe, chin, shoulder, and/or the like, may contact the touch display. In another example, a different object, such as a book, a card, a ball, and/or the like, may contact the touch display.

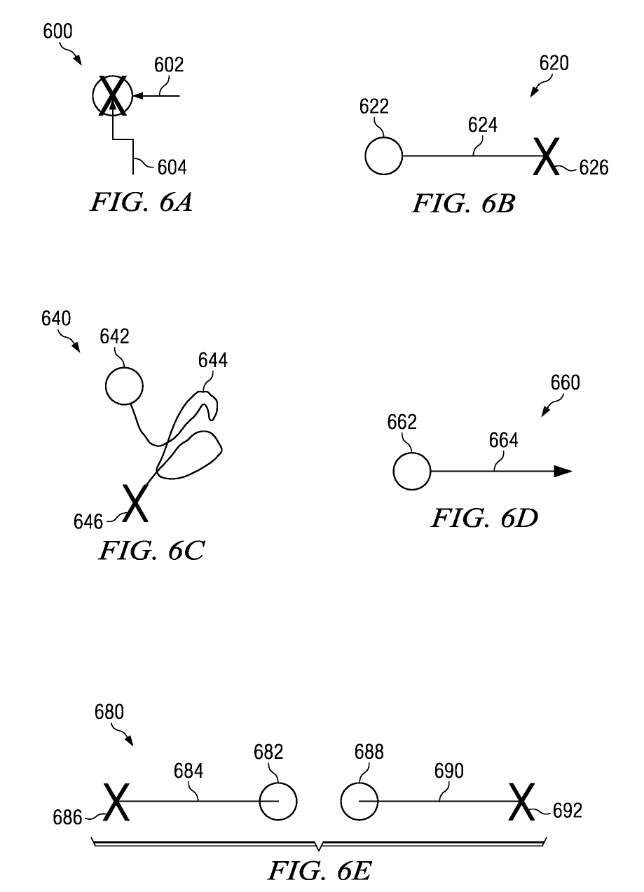

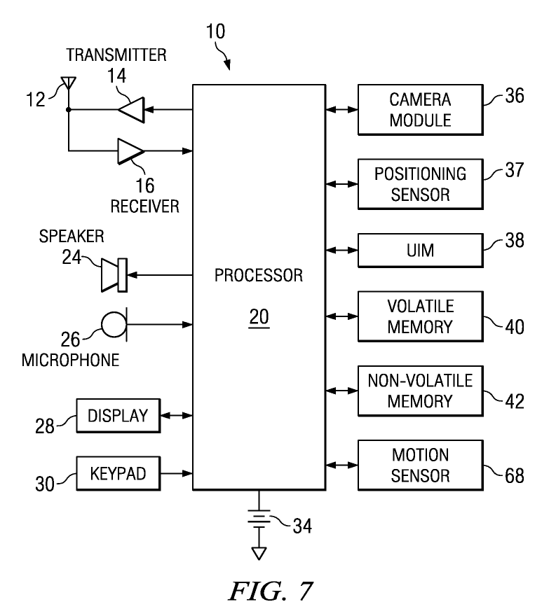

FIG. 1A is a diagram illustrating a tip 101 of a stylus 103 contacting a touch display 102, such as touch display 28 of FIG. 7, associated with a touch input, such as touch input 600 of FIG. 6A. Stylus 103 may be a device designed to be a stylus, or may be a device merely used as a stylus, such as a pen, a pencil, a pointer, and/or the like.

FIG. 1B is a diagram illustrating a finger tip 111 contacting a touch display 112, such as touch display 28 of FIG. 7, associated with a touch input, such as touch input 620 of FIG. 6B. Although the example of FIG. 1B illustrates the tip of an index finger, one or more other finger tips, such as a middle finger tip, may perform contact.

FIG. 1C is a diagram illustrating a finger pad 121 contacting a touch display 122, such as touch display 28 of FIG. 7, associated with a touch input, such as touch input 640 of FIG. 6C. In an example embodiment, the pad of a finger relates to a region of the finger between the tip of the finger and the joint of the finger closest to the tip. Although the example of FIG. 1C illustrates the pad of an index finger, one or more other finger pads, such as a thumb pad, may perform contact.

FIG. 1D is a diagram illustrating a majority part of finger 131 contacting a touch display 132, such as touch display 28 of FIG. 7, associated with a touch input, such as touch input 660 of FIG. 6D. In an example embodiment, the majority part of the finger relates to a region of the finger between the tip of the finger and a joint of the finger at least two joints away from the tip of the finger. Even though the example of FIG. 1D illustrates the bottom of the finger contacting the touch display, other faces, such as the back, of the finger may contact the touch display. Although the example of FIG. 1D illustrates the majority part of an index finger, one or more other majority parts of fingers, such as a majority part of a middle finger, may perform contact.

FIG. 1E is a diagram illustrating a majority part of finger 141 contacting a touch display 142, such as touch display 28 of FIG. 7, associated with a touch input, such as touch input 620 of FIG. 6B. In an example embodiment, the majority part of the finger relates to a region of the finger between the tip of the finger and a joint of the finger at least two joints away from the tip of the finger. Even though the example of FIG. 1E illustrates the side of the finger contacting the touch display, other faces, such as the back, of the finger may contact the touch display. Although the example of FIG. 1E illustrates the majority part of an index finger, one or more other majority parts of fingers, such as a majority part of a middle finger, may perform contact.

FIG. 1F is a diagram illustrating a hand 151 contacting a touch display 152, such as touch display 28 of FIG. 7, associated with a touch input, such as touch input 640 of FIG. 6C. In an example embodiment, a user may contact touch display 152 with the side of hand 151, the palm of hand 151, and/or the like.

FIG. 1G is a diagram illustrating a curved majority part of finger 161 contacting a touch display 162, such as touch display 28 of FIG. 7, associated with a touch input, such as touch input 660 of FIG. 6D. In an example embodiment, the majority part of the finger relates to a region of the finger between the tip of the finger and a joint of the finger at least two joints away from the tip of the finger. Even though the example of FIG. 1G illustrates the side of the finger contacting the touch display, other faces, such as the back, of the finger may contact the touch display. Although the example of FIG. 1G illustrates the majority part of an index finger, one or more other majority parts of fingers, such as a majority part of a middle finger, may perform contact.

FIG. 1H is a diagram illustrating a curved majority part of finger 171 contacting a touch display 172, such as touch display 28 of FIG. 7, associated with a touch input, such as touch input 620 of FIG. 6B. In an example embodiment, the majority part of the finger relates to a region of the finger between the tip of the finger and a joint of the finger at least two joints away from the tip of the finger. Even though the example of FIG. 1H illustrates the side of the finger contacting the touch display, other faces, such as the back, of the finger may contact the touch display. Although the example of FIG. 1H illustrates the majority part of a pinky finger, one or more other majority parts of fingers, such as a majority part of a thumb, may perform contact.

In an example embodiment, a user varies operations by varying the shape of the contact region associated with a touch input. For example, a user may vary the shape of a contact region when performing selection of an information item such as text, a media object, a storage object, and/or the like, to vary the selection. For example, the shape of a contact region may include an information item in a selection, and a different shape of a contact region may omit the information item.

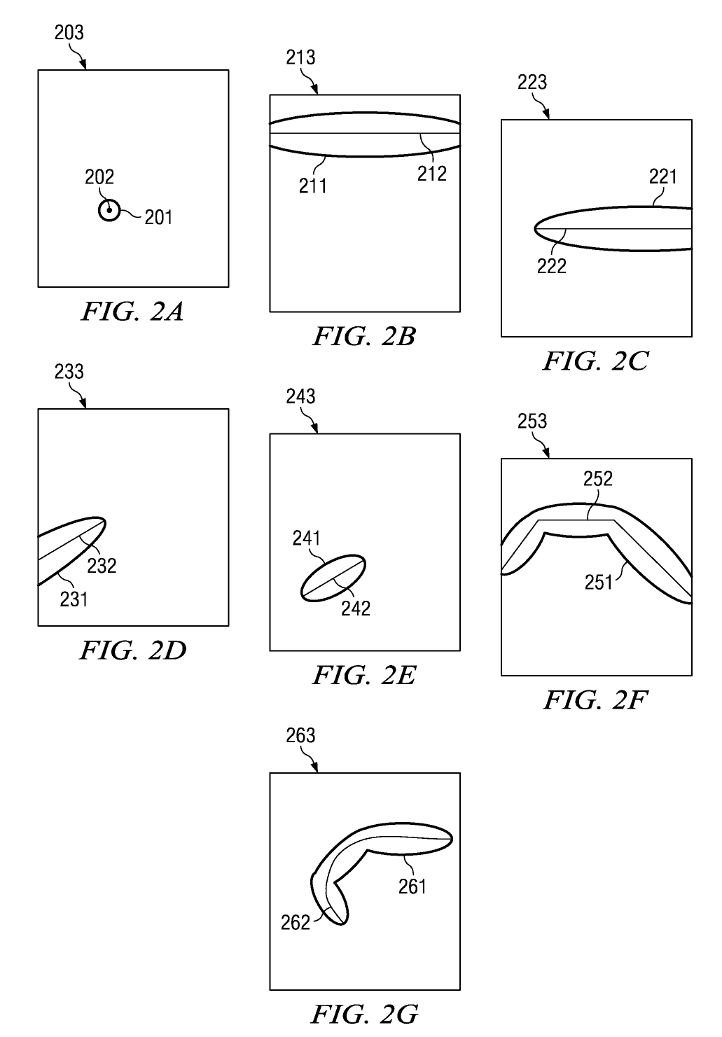

FIGS. 2A-2G are diagrams illustrating a linear shape associated with a contact region associated with a touch input according to an example embodiment of the invention. Although the contact regions of the examples of FIGS. 2A-2G illustrate elliptical regions, the shape of the contact region may vary and does not limit the invention.

The examples of FIGS. 2A-2G illustrate a linear shape in relation to a contact region. In an example embodiment, an apparatus may determine a linear shape to be at least one line that is at least partially within the contact region. For example, the linear shape may relate to the contact region's perimeter. In such an example, the linear shape may relate to at least part of the perimeter. In another example, the linear shape may relate to at least one line corresponding to a center of the contact region. In such an example, the center of the contact region may relate to an area distribution of the contact region, an interpolation of the contact region, and/or the like. In still another example, the linear shape may relate to angular deviations of the contact region. In such an example, each straight part of the contact region may relate to a straight line, and each straight line may intersect another straight line in relation to a part of the contact region associated with an angle deviation, such as related to a bent finger.

FIG. 2A is a diagram illustrating a linear shape 202 associated with a contact region 201 relative to a touch display 203. In an example embodiment, contact region 201 is associated with a touch display contact, such as the contact illustrated in FIG. 1A, and FIG. 1B. Contact region 201 may be associated with a touch input, such as touch input 600 of FIG. 6A.

FIG. 2B is a diagram illustrating a linear shape 212 associated with a contact region 211 relative to a touch display 213. In an example embodiment, contact region 211 is associated with a touch display contact, such as the contact illustrated in FIG. 1E and FIG. 1F. Contact region 211 may be associated with a touch input, such as touch input 620 of FIG. 6B.

FIG. 2C is a diagram illustrating a linear shape 222 associated with a contact region 221 relative to a touch display 223. In an example embodiment, contact region 221 is associated with a touch display contact, such as the contact illustrated in FIG. 1D. Contact region 221 may be associated with a touch input, such as touch input 640 of FIG. 6C.

FIG. 2D is a diagram illustrating a linear shape 232 associated with a contact region 231 relative to a touch display 233. In an example embodiment, contact region 231 is associated with a touch display contact, such as the contact illustrated in FIG. 1D. Contact region 231 may be associated with a touch input, such as touch input 660 of FIG. 6D.

FIG. 2E is a diagram illustrating a linear shape 242 associated with a contact region 241 relative to a touch display 243. In an example embodiment, contact region 241 is associated with a touch display contact, such as the contact illustrated in FIG. 1C. Contact region 241 may be associated with a touch input, such as touch input 600 of FIG. 6A.

FIG. 2F is a diagram illustrating a linear shape 252 associated with a contact region 251 relative to a touch display 253. In an example embodiment, contact region 251 is associated with a touch display contact, such as the contact illustrated in FIG. 1G. Contact region 251 may be associated with a touch input, such as touch input 620 of FIG. 6B.

FIG. 2G is a diagram illustrating a linear shape 262 associated with a contact region 261 relative to a touch display 263. In an example embodiment, contact region 261 is associated with a touch display contact, such as the contact illustrated in FIG. 1H. Contact region 261 may be associated with a touch input, such as touch input 640 of FIG. 6C.

In an example embodiment, a user provides a selection region by contacting the touch display and changing the contact. The change in the contact may relate to the user moving the contact on the touch display, the user changing the shape of the contact on the display, and/or the like. For example, a user may provide a selection region by contacting the touch display, and moving the contact to an end of the touch display. In another example, a user may provide a selection region by contacting the touch display, moving the contact on the touch display, and releasing the contact on the touch display. In still another example, a user may provide a selection region by contacting the touch display, moving the contact on the touch display, and releasing the contact during the movement.

In an example embodiment, the user may vary the shape of the contact with the touch display to vary a selection region. For example, the user may provide a contact with a straight shape, a curved shape, and/or the like.

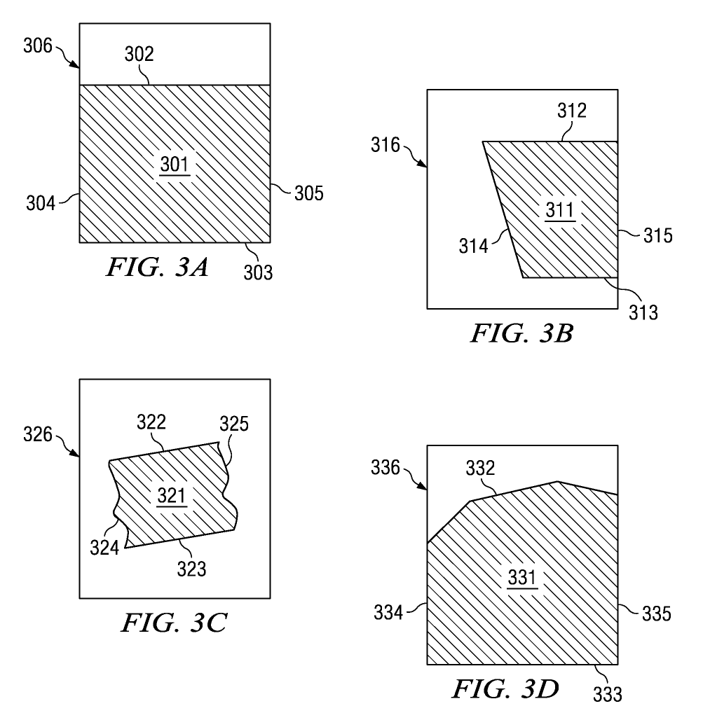

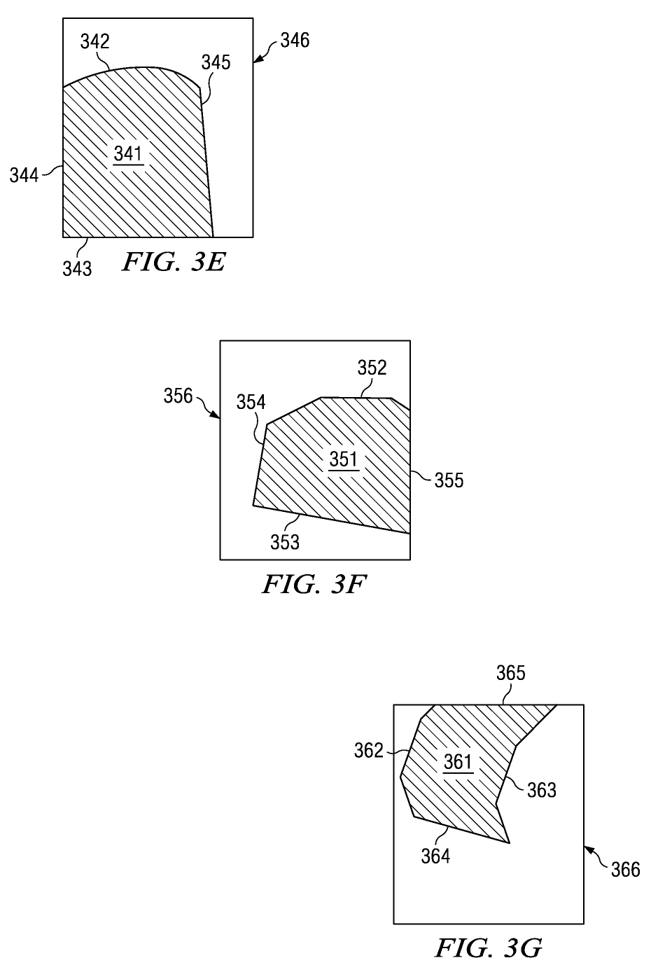

FIGS. 3A-3G are diagrams illustrating a selection region according to an example embodiment of the invention. The examples of FIGS. 3A-3G may relate to a touch input associated with a contact region. The selection regions of the example of FIGS. 3A-3G may relate to a change in the touch input, such as movement, release, change in contact region shape, and/or the like. For example, the selection region may relate to a region associated with a first linear shape and an end of the touch display. In another example, the selection region may relate to a region between two linear shapes at different positions. In such an example, the first linear shape may relate to a contact region associated with a contact input of a touch input, and the second linear shape may relate to a linear shape related to a contact region associated with a movement input of a touch input.

FIG. 3A is a diagram illustrating a selection region 301 according to an example embodiment of the invention. Selection region 301 relates to a region between linear shape 302, and display boundaries 303, 304, and 305 on touch display 306. Linear shape 302 may relate to a contact region, such as linear shape 212 relates to contact region 211 of FIG. 2B. Selection region 301 may relate to a user providing a contact such as illustrated in FIG. 1E, and performing a movement. For example, the user may provide a touch input associated with the contact, such as touch input 620 of FIG. 6B. In such an example, the user may perform the contact, such as illustrated in FIG. 1E, to provide the contact input, then perform a change in the touch input, such as move the contact to the bottom of the display and release the contact. In another example, the user may provide a touch input associated with the contact, such as touch input 660 of FIG. 6D. In such an example, the user may perform the contact, such as illustrated in FIG. 1E, to provide the contact input, and then perform a change in the touch input, such as release of the contact while moving the contact towards the bottom of the display. The apparatus may receive such input and determine the selection region to continue to the bottom of the display, the bottom of a page represented on the display, and/or the like.

FIG. 3B is a diagram illustrating a selection region 311 according to an example embodiment of the invention. Selection region 311 relates to a region between linear shape 312, linear shape 313, selection region boundary 314, and display boundary 315 on touch display 316. Linear shape 312 may relate to a contact region, such as linear shape 222 relates to contact region 221 of FIG. 2C. Selection region 311 may relate to a user providing a contact such as illustrated in FIG. 1D, and performing a movement. For example, the user may provide a touch input associated with the contact, such as touch input 620 of FIG. 6B. In such an example, the user may perform the contact, such as illustrated in FIG. 1D, to provide the contact input, then perform a change in the touch input, such as move the contact to a position where the linear shape associated with the contact region coincides with linear shape 313. Selection region boundary 314 may relate to a movement path associated with the touch input, a determined line between the touch input and the change in the touch input, and/or the like. For example, selection region boundary 314 may relate to a movement path of a contact associated with linear shape 312 and linear shape 313. In another example, selection region boundary 314 may relate to a determined line between the linear shape associated with a touch input and a linear shape associated with a change in the touch input. In the example of FIG. 3B, linear shape 312 and linear shape 313 are similar. For example, linear shape 312 and linear shape 313 are similarly straight, but have different lengths.

FIG. 3C is a diagram illustrating a selection region 321 according to an example embodiment of the invention. Selection region 321 relates to a region between linear shape 322, linear shape 323, selection region boundary 324, and selection region boundary 325 on touch display 326. Linear shape 322 may relate to a contact region, such as linear shape 242 relates to contact region 241 of FIG. 2E. Selection region 321 may relate to a user providing a contact such as illustrated in FIG. 1C, and performing a movement. For example, the user may provide a touch input associated with the contact, such as touch input 640 of FIG. 6C. In such an example, the user may perform the contact, such as illustrated in FIG. 1C, to provide the contact input, then perform a change in the touch input, such as move the contact to a position where the linear shape associated with the contact region coincides with linear shape 323. Selection region boundary 324 and selection boundary 325 may relate to a movement path associated with the touch input. For example, selection region boundary 324 and selection region boundary 325 may relate to a movement path between the linear shape associated with a touch input and a linear shape associated with a change in the touch input. In the example of FIG. 3C, linear shape 322 and linear shape 323 the same. For example, linear shape 322 and linear shape 323 have the same lengths, orientations, and/or the like. In an example embodiment, a user may provide a contact input, such as illustrated in FIG. 1C, with an associated contact region, such as contact region 241 of FIG. 2E, which the user moves along a path reflected by selection region boundaries 324 and 325, then removes the contact input in relation to linear shape 323, for selection region 321.

FIG. 3D is a diagram illustrating a selection region 331 according to an example embodiment of the invention. Selection region 331 relates to a region between linear shape 332, and display boundaries 333, 334, and 335 on touch display 336. Linear shape 332 may relate to a contact region, such as linear shape 252 relates to contact region 251 of FIG. 2F. Selection region 331 may relate to a user providing a contact such as illustrated in FIG. 1G, and performing a movement. For example, the user may provide a touch input associated with the contact, such as touch input 620 of FIG. 6B. In such an example, the user may perform the contact, such as illustrated in FIG. 1G, to provide the contact input, then perform a change in the touch input, such as move the contact to the bottom of the display and release the contact. In another example, the user may provide a touch input associated with the contact, such as touch input 660 of FIG. 6D. In such an example, the user may perform the contact, such as illustrated in FIG. 1G, to provide the contact input, and then perform a change in the touch input, such as release the contact while moving the contact towards the bottom of the display. The apparatus may receive such input and determine the selection region to continue to the bottom of the display, the bottom of a page represented on the display, and/or the like.

FIG. 3E is a diagram illustrating a selection region 341 according to an example embodiment of the invention. Selection region 341 relates to a region between linear shape 342, display boundaries 343 and 344, and selection region boundary 345 on touch display 346. Linear shape 342 may relate to a contact region, such as linear shape 262 relates to contact region 261 of FIG. 2G. Selection region boundary 345 may relate to a movement path associated with the touch input, a determined line between the touch input and the change in the touch input, and/or the like. For example, selection region boundary 345 may relate to a movement path of a contact associated with linear shape 342 and linear shape 343. In another example, selection region boundary 345 may relate to a determined line between the linear shape associated with a touch input and a linear shape associated with a change in the touch input. Selection region 341 may relate to a user providing a contact such as illustrated in FIG. 1H, and performing a movement. For example, the user may provide a touch input associated with the contact, such as touch input 620 of FIG. 6B. In such an example, the user may perform the contact, such as illustrated in FIG. 1H, to provide the contact input, then perform a change in the touch input, such as move the contact to the bottom of the display and release the contact. In another example, the user may provide a touch input associated with the contact, such as touch input 660 of FIG. 6D. In such an example, the user may perform the contact, such as illustrated in FIG. 1H, to provide the contact input, and then perform a change in the touch input, such as release the contact while moving the contact towards the bottom of the display. The apparatus may receive such input and determine the selection region to continue to the bottom of the display, the bottom of a page represented on the display, and/or the like.

FIG. 3F is a diagram illustrating a selection region 351 according to an example embodiment of the invention. Selection region 351 relates to a region between linear shape 352, linear shape 353, selection region boundary 354, and display boundary 355 on touch display 356. Linear shape 352 may relate to a contact region, such as contact region 261 of FIG. 2G. Selection region 351 may relate to a user providing a contact such as illustrated in FIG. 1H, and performing a movement. For example, the user may provide a touch input associated with the contact, such as touch input 620 of FIG. 6B. In such an example, the user may perform the contact, such as illustrated in FIG. 1H, to provide the contact input, then perform a change in the touch input and contact region, such as move the contact to a position where the linear shape associated with the contact region coincides with linear shape 353. Selection region boundary 354 may relate to a movement path associated with the touch input, a determined line between the touch input and the change in the touch input, and/or the like. For example, selection region boundary 354 may relate to a movement path of a contact associated with linear shape 352 and linear shape 353. In another example, selection region boundary 354 may relate to a determined line between the linear shape associated with a touch input and a linear shape associated with a change in the touch input. In the example of FIG. 3F, linear shape 352 and linear shape 353 differ. For example linear shape 352 relates to a plurality of intersecting lines, and linear shape 353 relates to a line.

FIG. 3G is a diagram illustrating a selection region 361 according to an example embodiment of the invention. Selection region 361 relates to a region between linear shape 362, linear shape 363, selection region boundary 364, and display boundary 365 on touch display 366. Linear shape 362 may relate to a contact region, such as contact region 261 of FIG. 2G. Selection region 361 may relate to a user providing a contact such as illustrated in FIG. 1H, and performing a movement. For example, the user may provide a touch input associated with the contact, such as touch input 620 of FIG. 6B. In such an example, the user may perform the contact, such as illustrated in FIG. 1H, to provide the contact input, then perform a change in the touch input, such as move the contact to a position where the linear shape associated with the contact region coincides with linear shape 363. Selection region boundary 364 may relate to a movement path associated with the touch input, a determined line between the touch input and the change in the touch input, and/or the like. For example, selection region boundary 364 may relate to a movement path of a contact associated with linear shape 362 and linear shape 363. In another example, selection region boundary 364 may relate to a determined line between the linear shape associated with a touch input and a linear shape associated with a change in the touch input. In the example of FIG. 3G, linear shape 362 and linear shape 363 are similar. For example, linear shape 362 and linear shape 363 comprise a plurality of connected lines at similar angles, but one of the lines has a different length.

In an example embodiment, an apparatus performs a selection based on a selection region. For example, the apparatus may select at least one information item based, at least in part, on an overlap of the selection region and a visual representation of the at least one information item. An information item may relate to text, such as numbers, characters, control characters, and/or the like. An information item may relate to a media object, such as audio, video, an image, a song, metadata, and/or the like. An information item may relate to computer storage, such as a file, a folder, a directory, and/or the like.

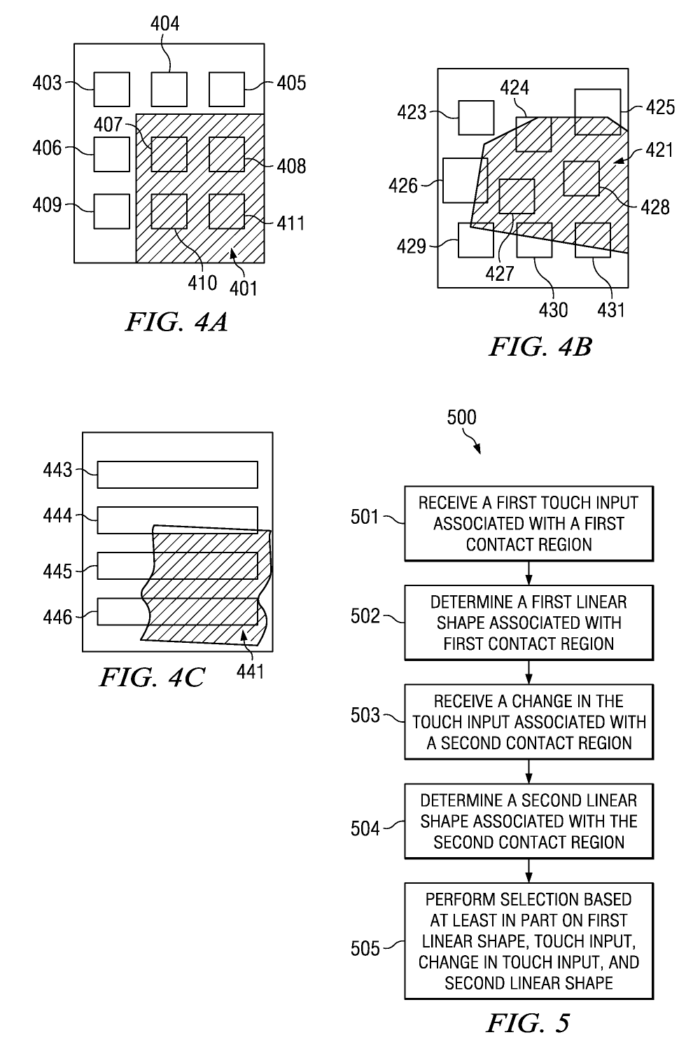

FIGS. 4A-4C are diagrams illustrating a selection region in relation to visual representations of information items according to an example embodiment of the invention.

FIG. 4A is a diagram illustrating a selection region 401, such as selection region 311 of FIG. 3B, in relation to visual representations of information items 403-411. In the example of FIG. 4A, visual representations of information items 403-411 are arranged in a two dimensional arrangement, and selection region 401 overlaps the entirety of visual representations of information items, 407, 408, 410, and 411. In an example embodiment an apparatus performs selection based, at least in part, on a selection region overlapping the entirety of a visual representation of a selection region. For example, the apparatus may select information items associated with visual representations 407, 408, 410, and 411. In an example embodiment, an apparatus may select an information item based, at least in part, on the selection region overlapping with a row associated with the visual representation of the information item. For example, the apparatus may select information items associated with visual representations 406-411.

FIG. 4B is a diagram illustrating a selection region 421, such as selection region 351 of FIG. 3F, in relation to visual representations of information items 423-431. In the example of FIG. 4B, visual representations of information items 423-431 are arranged in a two dimensional arrangement, and selection region 421 overlaps at least parts of visual representations of information items 424-431. In an example embodiment an apparatus performs selection based, at least in part, on a selection region overlapping the entirety of a visual representation of a selection region. For example, the apparatus may select information items associated with visual representations 427 and 428. In an example embodiment an apparatus performs selection based, at least in part, on a selection region overlapping the majority of a visual representation of a selection region. For example, the apparatus may select information items associated with visual representations 424, 427, 428, and 431. In an example embodiment an apparatus performs selection based, at least in part, on a selection region overlapping a part of a visual representation of a selection region. For example, the apparatus may select information items associated with visual representations 424-431.

FIG. 4C is a diagram illustrating a selection region 441, such as selection region 321 of FIG. 3C, in relation to visual representations of information items 443-446. In the example of FIG. 4C, visual representations of information items 443-446 are arranged in a sequential arrangement, and selection region 441 overlaps at least parts of visual representations of information items 444-446. In an example embodiment an apparatus performs selection based, at least in part, on a selection region overlapping the entirety of a visual representation of a selection region. For example, the apparatus may select no information items in the example of FIG. 4C. In an example embodiment an apparatus performs selection based, at least in part, on a selection region overlapping the majority of a visual representation of a selection region. For example, the apparatus may select information items associated with visual representations 445 and 446. In an example embodiment an apparatus performs selection based, at least in part, on a selection region overlapping a part of a visual representation of a selection region. For example, the apparatus may select information items associated with visual representations 444-446.

FIG. 5 is a flow diagram showing operations 500 for performing selection based on a touch input according to an example embodiment of the invention. An apparatus, for example electronic device 10 of FIG. 7, may utilize the set of operations 500. The apparatus may comprise means, such as a processor, a computer program product and/or the like, for performing the operations of FIG. 5. In the example of FIG. 5, the designation of first and second are used to differentiate without regard any sequential ordering, if any, and do not limit the scope of the invention. For example, an apparatus may determine a first linear shape before a second linear shape, after a second linear shape, concurrently with a second linear shape, and/or the like. Additionally, reference will be made to receipt of a touch input and the receipt of a change in the touch input. Depending upon the portion of the apparatus to which reference is being made, receipt of the touch input and receipt of the change in the touch input may refer to the receipt of the actual touch input, such as in instances in which reference is being made to the touch display, or receipt of an indication of, such as a signal generated by and indicative of, the touch input, such as in instances in which reference is being made to the processor. As used herein, reference to the receipt of a touch input and the receipt of the change in the touch input is therefore intended to include both receipt of the actual touch input as well as receipt of an indication of a touch input. The indication of the touch input may comprise a signal, data, a data structure, a software class, and/or the like. The apparatus may receive the indication from hardware and/or software by signal, message, method call, function call, and/or the like.

At block 501, the apparatus receives a touch input associated with a first contact region. The touch input may comprise position information, time information, speed information, and/or the like. A touch display, for example display 28, of FIG. 7, may receive the touch input. The apparatus may receive the touch input after the touch input terminates, before the touch input terminates, and/or the like. For example, the apparatus may receive the touch input while a user is performing the touch input. In another example, the apparatus may receive the touch input after the user has terminated a touch input. The apparatus may associate the first touch input with a contact region, such as contact regions illustrated in FIGS. 2A-2G, related to a user touch display contact, such as illustrated in FIGS. 1A-1H. For example, the first touch input may relate to touch input 600 of FIG. 6A, associated with contact region 201 of FIG. 2A, which may relate to a finger tip contact, such as illustrated in FIG. 1B, a stylus, such as in FIG. 1A, and/or the like. In still another example, the first touch input may relate to touch input 640 of FIG. 6C, contact input 642 of FIG. 6C, and/or the like, associated with contact region 241 of FIG. 2E, which may relate to a finger pad contact, such as illustrated in FIG. 1C. In yet another example, the first touch input may relate to a touch input, such as input 660 of FIG. 6D, contact input 662 of FIG. 6D, and/or the like, associated with contact region 231 of FIG. 2D, which relates to a majority part of a finger, such as illustrated in FIGS. 1D and 1E.

At block 502, the apparatus determines a first linear shape associated with the first contact region. The apparatus may determine the first linear shape, at least partially, within the first contact region. For example, the apparatus may determine an interpolation of a linear shape intersection with ends of a contact region. In another example, the apparatus may determine the linear shape in relation to the contact region's perimeter. In still another example, the apparatus may determine at least one cross-sectional center where the linear shape may intersect. The linear shape may relate to a straight line, such as linear shape 212 of FIG. 2B, linear shape 222 of FIG. 2C, linear shape 232 of FIG. 2D, linear shape 242 of FIG. 2E, and/or the like. The linear shape may relate to a plurality of intersecting lines, such as linear shape 252 of FIG. 2F. The linear shape may relate to a curved line, such as linear shape 262 of FIG. 2G.

At block 503, the apparatus receives a change in the touch input associated with a second contact region. The second contact region may be similar as described with reference to block 501. The change in touch input may relate to a movement input, such as movement input 624 of touch input 620 of FIG. 6B, release input 626 of FIG. 6B, and/or the like. The second contact region may be different from the first contact region, similar to the first contact region, the same as the first contact region, and/or the like. For example, the first contact region and second contact region may relate to a finger pad, such as contact region 241 of FIG. 2E. In another example, the first contact region may relate to a straight finger, such as contact region 221 of FIG. 2C, and the second contact region may relate to a curved finger, such as contact region 261 of FIG. 2G.

At block 504, the apparatus determines a second linear shape associated with the second contact region. The determination of the second linear shape may be similar as described with reference to block 502. The second linear shape may be different from the first linear shape, similar to the first linear shape, the same as the first linear shape, and/or the like. For example, the first contact region and second contact region may relate to a straight line, such as linear shape 222 of FIG. 2C. In another example, the first contact region may relate to a straight line such as linear shape 212 of FIG. 2B, and the second contact region may relate to a plurality of intersecting lines, such as linear shape 252 of FIG. 2F.

At block 505, the apparatus performs selection based at least in part on the first linear shape, the touch input, the change in the touch input, and the second linear shape. The selection may relate to one or more various arrangements of visual representations of information items. The information items may relate to text, storage, media objects, and/or the like. The arrangement may relate to a sequential arrangement, such as illustrated in FIG. 4C, a two dimensional arrangement, such as illustrated in FIG. 4A, a three dimensional arrangement, and/or the like. A text information items may relate to one or more characters, numbers, control characters, and/or the like. A media object information item may relate to audio, video, an image, a song, metadata, and/or the like. A computer storage information item may relate to a folder, a directory, and/or the like. For example, selection may relate to one or more images. In another example, selection may relate to information associated with a webpage of a browser program, such as text, an image, and/or the like.

In an example embodiment, the selection relates to a selection region, such as illustrated in the examples of FIGS. 3A-3G, based, at least in part, on the first linear shape, the touch input, the change in the touch input, and the second linear shape. For example, the selecting may relate to the selection region overlapping with a visual representation of an information item, such as illustrated in FIGS. 4A-4C. In such an example, the overlapping may relate to the selection region overlapping the entirety of, a majority of, and/or a part of the visual representation of the information item. In another example, the selecting may relate to the selection region overlapping with a row associated with the visual representation of an information item. In such an example, the overlapping may relate to the selection region overlapping the entirety, the majority, and/or a part of the row associated with the visual representation of the information item.

FIGS. 6A-6E are diagrams illustrating input from a touch display, for example from display 28 of FIG. 7, according to an example embodiment of the invention. In FIGS. 6A-6E, a circle represents an input related to contact with a touch display, two crossed lines represent an input related to releasing a contact from a touch display, and a line represents input related to movement on a touch display.

In the example of FIG. 6A, input 600 relates to receiving contact input 602 and receiving a release input 604. In this example, contact input 602 and release input 604 occur at the same position. In an example embodiment, an apparatus utilizes the time between receiving contact input 602 and release input 604. For example, the apparatus may interpret input 600 as a tap for a short time between contact input 602 and release input 604, as a press for a longer time between contact input 602 and release input 604, and/or the like. In such an example, a tap input may induce one operation, such as selecting an item, and a press input may induce another operation, such as performing an operation on an item. In another example, a tap and/or press may relate to a user selected text position.

In the example of FIG. 6B, input 620 relates to receiving contact input 622, a movement input 624, and a release input 626. In this example, contact input 622 and release input 626 occur at different positions. Input 620 may relate to dragging an object from one position to another, to moving a scroll bar, to panning a virtual screen, to drawing a shape, and/or the like. In an example embodiment, an apparatus interprets input 620 based at least in part on the speed of movement 624. For example, if input 620 relates to panning a virtual screen, the panning motion may be small for a slow movement, large for a fast movement, and/or the like. In another example embodiment, an apparatus interprets input 620 based at least in part on the distance between contact input 622 and release input 626. For example, if input 620 relates to a scaling operation, such as resizing a box, the scaling may relate to the distance between contact input 622 and release input 626. An apparatus may interpret the input before receiving release input 626. For example, the apparatus may evaluate a change in the input, such as speed, position, and/or the like. In such an example, the apparatus may perform one or more determinations based upon the change in the touch input. In such an example, the apparatus may modify a text selection point based at least in part on the change in the touch input.

In the example of FIG. 6C, input 640 relates to receiving contact input 642, a movement input 644, and a release input 646 are shown. In this example, contact input 642 and release input 646 occur at different positions. Input 640 may relate to dragging an object from one position to another, to moving a scroll bar, to panning a virtual screen, to drawing a shape, and/or the like. In an example embodiment, an apparatus interprets input 640 based at least in part on the speed of movement 644. For example, if input 640 relates to panning a virtual screen, the panning motion may be small for a slow movement, large for a fast movement, and/or the like. In another example embodiment, an apparatus interprets input 640 based at least in part on the distance between contact input 642 and release input 646. For example, if input 640 relates to a scaling operation, such as resizing a box, the scaling may relate to the distance between contact input 642 and release input 646. In still another example embodiment, the apparatus interprets the position of the release input. In such an example, the apparatus may modify a text selection point based at least in part on the change in the touch input.

In the example of FIG. 6D, input 660 relates to receiving contact input 662, and a movement input 664, where contact is released during movement. Input 660 may relate to dragging an object from one position to another, to moving a scroll bar, to panning a virtual screen, to drawing a shape, and/or the like. In an example embodiment, an apparatus interprets input 660 based at least in part on the speed of movement 664. For example, if input 660 relates to panning a virtual screen, the panning motion may be small for a slow movement, large for a fast movement, and/or the like. In another example embodiment, an apparatus interprets input 660 based at least in part on the distance associated with the movement input 664. For example, if input 660 relates to a scaling operation, such as resizing a box, the scaling may relate to the distance of the movement input 664 from the contact input 662 to the release of contact during movement.

In an example embodiment, an apparatus may receive multiple touch inputs at coinciding times. For example, there may be a tap input at a position and a different tap input at a different location during the same time. In another example there may be a tap input at a position and a drag input at a different position. An apparatus may interpret the multiple touch inputs separately, together, and/or a combination thereof. For example, an apparatus may interpret the multiple touch inputs in relation to each other, such as the distance between them, the speed of movement with respect to each other, and/or the like.

In the example of FIG. 6E, input 680 relates to receiving contact inputs 682 and 688, movement inputs 684 and 690, and release inputs 686 and 692. In this example, contact input 682 and 688, and release input 686 and 692 occur at different positions. Input 680 may be characterized as a multiple touch input. Input 680 may relate to dragging an object from one position to another, to moving a scroll bar, to panning a virtual screen, to drawing a shape, indicating one or more user selected text positions and/or the like. In an example embodiment, an apparatus interprets input 680 based at least in part on the speed of movements 684 and 690. For example, if input 680 relates to zooming a virtual screen, the zooming motion may be small for a slow movement, large for a fast movement, and/or the like. In another example embodiment, an apparatus interprets input 680 based at least in part on the distance between contact inputs 682 and 688 and release inputs 686 and 692. For example, if input 680 relates to a scaling operation, such as resizing a box, the scaling may relate to the collective distance between contact inputs 682 and 688 and release inputs 686 and 692.

In an example embodiment, the timing associated with the apparatus receiving contact inputs 682 and 688, movement inputs 684 and 690, and release inputs 686 and 692 varies. For example, the apparatus may receive contact input 682 before contact input 688, after contact input 688, concurrent to contact input 688, and/or the like. The apparatus may or may not utilize the related timing associated with the receiving of the inputs. For example, the apparatus may utilize an input received first by associating the input with a preferential status, such as a primary selection point, a starting position, and/or the like. In another example, the apparatus may utilize non-concurrent inputs as if the apparatus received the inputs concurrently. In such an example, the apparatus may utilize a release input received first the same way that the apparatus would utilize the same input if the apparatus had received the input second.

Even though an aspect related to two touch inputs may differ, such as the direction of movement, the speed of movement, the position of contact input, the position of release input, and/or the like, the touch inputs may be similar. For example, a first touch input comprising a contact input, a movement input, and a release input, may be similar to a second touch input comprising a contact input, a movement input, and a release input, even though they may differ in the position of the contact input, and the position of the release input.

FIG. 7 is a block diagram showing an apparatus, such as an electronic device 10, according to an example embodiment of the invention. It should be understood, however, that an electronic device as illustrated and hereinafter described is merely illustrative of an electronic device that could benefit from embodiments of the present invention and, therefore, should not be taken to limit the scope of the present invention. While one embodiment of the electronic device 10 is illustrated and will be hereinafter described for purposes of example, other types of electronic devices, such as, but not limited to, portable digital assistants (PDAs), pagers, mobile computers, desktop computers, televisions, gaming devices, laptop computers, cameras, video recorders, global positioning system (GPS) devices and other types of electronic systems, may readily employ embodiments of the present invention.

Furthermore, devices may readily employ embodiments of the present invention regardless of their intent to provide mobility. In this regard, even though embodiments of the present invention are described in conjunction with mobile communications applications, it should be understood that embodiments of the present invention may be utilized in conjunction with a variety of other applications, both in the mobile communications industries and outside of the mobile communications industries.

The electronic device 10 may comprise an antenna 12 (or multiple antennae) in operable communication with a transmitter 14 and a receiver 16. The electronic device 10 may further comprise a processor 20 or other processing element that provides signals to and receives signals from the transmitter 14 and receiver 16, respectively. The signals may comprise signaling information in accordance with a communications interface standard, user speech, received data, user generated data, and/or the like. The electronic device 10 may operate with one or more air interface standards, communication protocols, modulation types, and access types. By way of illustration, the electronic device 10 may operate in accordance with any of a number of first, second, third and/or fourth-generation communication protocols or the like. For example, the electronic device 10 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), or with fourth-generation (4G) wireless communication protocols, wireless networking protocols, such as 802.11, short-range wireless protocols, such as Bluetooth, and/or the like.

Processor 20 may comprise means, such as circuitry for implementing audio, video, communication, navigation, logic functions, and/or the like, as well as for implementing embodiments of the present invention including, for example, one or more of the functions described in conjunction with FIGS. 2-6. For example, processor 20 may comprise means, such as one or more digital signal processor devices, microprocessor devices, various analog to digital converters, digital to analog converters, and other support circuits, for performing various functions including, for example, one or more of the functions described in conjunction with FIGS. 2-6. The apparatus may perform control and signal processing functions of the electronic device 10 among these devices according to their respective capabilities. The processor 20 thus may comprise the functionality to encode and interleave message and data prior to modulation and transmission. The processor 20 may additionally comprise an internal voice coder, and may comprise an internal data modem. Further, the processor 20 may comprise functionality to operate one or more software programs, which may be stored in memory and which may, among other things, cause the processor 20 to implement at least one embodiment of the invention including, for example, one or more of the functions described in conjunction with FIGS. 2-6. For example, the processor 20 may operate a connectivity program, such as a conventional internet browser. The connectivity program may allow the electronic device 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic device 10 may comprise a user interface for providing output and/or receiving input. The electronic device 10 may comprise an output device such as a ringer, a conventional earphone and/or speaker 24, a microphone 26, a display 28, and/or a user input interface, which are coupled to the processor 20. The user input interface, which allows the electronic device 10 to receive data, may comprise one or more devices that may allow the electronic device 10 to receive data, such as a keypad 30, a touch display, for example if display 28 comprises touch capability, and/or the like. In an embodiment comprising a touch display, the touch display may be configured to receive input from a single point of contact, multiple points of contact, and/or the like. In such an embodiment, the touch display may determine input based on position, motion, speed, contact area, and/or the like.

The electronic device 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display.

In embodiments including the keypad 30, the keypad 30 may comprise numeric (for example, 0-9) keys, symbol keys (for example, #, *), alphabetic keys, and/or the like for operating the electronic device 10. For example, the keypad 30 may comprise a conventional QWERTY keypad arrangement. The keypad 30 may also comprise various soft keys with associated functions. In addition, or alternatively, the electronic device 10 may comprise an interface device such as a joystick or other user input interface. The electronic device 10 further comprises a battery 34, such as a vibrating battery pack, for powering various circuits that are required to operate the electronic device 10, as well as optionally providing mechanical vibration as a detectable output.

In an example embodiment, the electronic device 10 comprises a media capturing element, such as a camera, video and/or audio module, in communication with the processor 20. The media capturing element may be any means for capturing an image, video and/or audio for storage, display or transmission. For example, in an example embodiment in which the media capturing element is a camera module 36, the camera module 36 may comprise a digital camera which may form a digital image file from a captured image. As such, the camera module 36 may comprise hardware, such as a lens or other optical component(s), and/or software necessary for creating a digital image file from a captured image. Alternatively, the camera module 36 may comprise only the hardware for viewing an image, while a memory device of the electronic device 10 stores instructions for execution by the processor 20 in the form of software for creating a digital image file from a captured image. In an example embodiment, the camera module 36 may further comprise a processing element such as a co-processor that assists the processor 20 in processing image data and an encoder and/or decoder for compressing and/or decompressing image data. The encoder and/or decoder may encode and/or decode according to a standard format, for example, a Joint Photographic Experts Group (JPEG) standard format.

The electronic device 10 may comprise one or more user identity modules (UIM) 38. The UIM may comprise information stored in memory of electronic device 10, a part of electronic device 10, a device coupled with electronic device 10, and/or the like. The UIM 38 may comprise a memory device having a built-in processor. The UIM 38 may comprise, for example, a subscriber identity module (SIM), a universal integrated circuit card (UICC), a universal subscriber identity module (USIM), a removable user identity module (R-UIM), and/or the like. The UIM 38 may store information elements related to a subscriber, an operator, a user account, and/or the like. For example, UIM 38 may store subscriber information, message information, contact information, security information, program information, and/or the like. Usage of one or more UIM 38 may be enabled and/or disabled. For example, electronic device 10 may enable usage of a first UIM and disable usage of a second UIM.

In an example embodiment, electronic device 10 comprises a single UIM 38. In such an embodiment, at least part of subscriber information may be stored on the UIM 38.

In another example embodiment, electronic device 10 comprises a plurality of UIM 38. For example, electronic device 10 may comprise two UIM 38 blocks. In such an example, electronic device 10 may utilize part of subscriber information of a first UIM 38 under some circumstances and part of subscriber information of a second UIM 38 under other circumstances. For example, electronic device 10 may enable usage of the first UIM 38 and disable usage of the second UIM 38. In another example, electronic device 10 may disable usage of the first UIM 38 and enable usage of the second UIM 38. In still another example, electronic device 10 may utilize subscriber information from the first UIM 38 and the second UIM 38.

Electronic device 10 may comprise one or more memory devices including, in one embodiment, volatile memory 40, such as volatile Random Access Memory (RAM) including a cache area for the temporary storage of data. The electronic device 10 may also comprise other memory, for example, non-volatile memory 42, which may be embedded and/or may be removable. The non-volatile memory 42 may comprise an EEPROM, flash memory or the like. The memories may store any of a number of pieces of information, and data. The information and data may be used by the electronic device 10 to implement one or more functions of the electronic device 10, such as the functions described in conjunction with FIGS. 2-6. For example, the memories may comprise an identifier, such as an international mobile equipment identification (IMEI) code, which may uniquely identify the electronic device 10.

Although FIG. 7 illustrates an example of an electronic device that may utilize embodiments of the present invention including those described and depicted, for example, in FIGS. 2-6, electronic device 10 of FIG. 7 is merely an example of a device that may utilize embodiments of the present invention.

Without in any way limiting the scope, interpretation, or application of the claims appearing below, a technical effect of one or more of the example embodiments disclosed herein is reducing processor operations by allowing a user to provide fewer touch inputs to perform selection by modifying the shape of a contact region associated with the touch inputs. Another technical effect of one or more of the example embodiments disclosed herein is reducing the amount of time a processor spends awaiting user input.

Embodiments of the present invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media. In the context of this document, a “computer-readable medium” may be any media or means that can contain, or store the instructions for use by or in connection with an instruction execution system, apparatus, or device, such as a computer, with one example of a computer described and depicted in FIG. 7. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising a processor configured to cause the apparatus to:
receive an indication of a touch input associated with a first contact region;
determine a first linear shape associated with said first contact region;
receive an indication of a change in said touch input associated with a second contact region;
determine a second linear shape associated with said second contact region; and
perform selection based at least in part on said first linear shape, said touch input, said change in said touch input, and said second linear shape.

2-56. (canceled)

57. The apparatus of claim 1, wherein said first contact region and said second contact region are different.

58. The apparatus of claim 1, wherein at least one of said first contact region and said second contact region relates to majority part of finger.

59. The apparatus of claim 1, wherein said first linear shape and said second linear shape are different.

60. The apparatus of claim 1, wherein said processor is configured to determine at least one of said first linear shape and said second linear shape to be, at least partially, within said first contact region and said second contact region, respectively.

61. The apparatus of claim 1, wherein at least one of said first linear shape and said second linear shape relate to a straight line.

62. The apparatus of claim 1, wherein at least one of said first linear shape and said second linear shape relate to a plurality of intersecting lines.

63. The apparatus of claim 1, wherein at least one of said first linear shape and said second linear shape relate to a curved line.

64. The apparatus of claim 1, wherein said change in said touch input relates to movement.

65. The apparatus of claim 1, wherein said selection comprises the selection of at least one information item from a sequential arrangement of visual representations of information items.

66. The apparatus of claim 1, wherein said selection comprises the selection of at least one information item from a two dimensional arrangement of visual representations of information items.

67. The apparatus of claim 1, wherein said selecting comprises determining a selection region based, at least in part, on said first linear shape, said touch input, said change in said touch input, and said second linear shape.

68. The apparatus of claim 67, wherein said selecting relates to said selection region overlapping with a visual representation of an information item.

69. The apparatus of claim 67, wherein said overlapping relates to said selection region overlapping the entirety of said visual representation of said information item.

70. The apparatus of claim 67, wherein said overlapping relates to said selection region overlapping a majority of said visual representation of said information item.

71. The apparatus of claim 67, wherein said selecting relates to said selection region overlapping with a row associated with said visual representation of said information item.

72. The apparatus of claim 71, wherein said overlapping relates to said selection region overlapping a majority of said row associated with said visual representation of an information item.

73. The apparatus of claim 1, wherein the processor comprises at least one memory that contains executable instructions that if executed by the processor cause the apparatus to:
receive an indication of a touch input associated with a first contact region;
determine a first linear shape associated with said first contact region;
receive an indication of a change in said touch input associated with a second contact region;
determine a second linear shape associated with said second contact region; and
perform selection based at least in part on said first linear shape, said touch input, said change in said touch input, and said second linear shape.

74. A method, comprising:
receiving an indication of a touch input associated with a first contact region;
determining a first linear shape associated with said first contact region;
receiving an indication of a change in said touch input associated with a second contact region;
determining a second linear shape associated with said second contact region; and
performing selection based at least in part on said first linear shape, said touch input, said change in said touch input, and said second linear shape.

75. A computer-readable medium encoded with instructions that, when executed by a computer, perform:
receiving an indication of a touch input associated with a first contact region;
determining a first linear shape associated with said first contact region;
receiving a change in said touch input associated with a second contact region;
determining an indication of a second linear shape associated with said second contact region; and
performing selection based at least in part on said first linear shape, said touch input, said change in said touch input, and said second linear shape.
